(19) United States
(12) Patent Application Publication
(10) Pub. No.: US 2014/0122644 A1
(43) Pub. Date: May 1, 2014

(54) COMPUTER-BASED EXPLORATION, RESEARCH AND CONTROL OF TV

(71) Applicant: Google Inc., Mountain View, CA (US)

(72) Inventors: Alexander Friedrich KUSCHER, San Francisco, CA (US); Caesar Sengupta, Sunnyvale, CA (US); Trond Thomas Wuellner, Mountain View, CA (US)

(73) Assignee: Google Inc., Mountain View, CA (US)

(21) Appl. No.: 13/778,058

(22) Filed: Feb. 26, 2013

Related U.S. Application Data
(60) Provisional application No. 61/719,895, filed on Oct. 29, 2012.

(51) Int. Cl. H04L 29/08

(52) U.S. Cl. CPC H04L 29/08117
USPC 709/217

(57) ABSTRACT

A method for transferring content includes transferring content from a first device to a second device in response to a request from the first device to transfer the content, analyzing the transferred content at the second device, to determine a type of the transferred content and providing the transferred content for display at the second device according to the determined type of the transferred content.

### CROSS-REFERENCE TO RELATED APPLICATIONS

The present application claims the benefit of priority under 35 U.S.C. §119 from U.S. Provisional Patent Application Ser. No. 61/719,895 entitled “COMPUTER-BASED EXPLORATION, RESEARCH AND CONTROL OF TV,” filed on Oct. 29, 2012, the disclosure of which is hereby incorporated by reference in its entirety for all purposes.

### BACKGROUND

When sharing content between two or more devices, a local device processes the content and displays it, and another, remote device, displays the content already displayed at the local device. Such content sharing techniques may be implemented by streaming content that is displayed on a local device to a remote device. However, the local device does all of the content processing and is actively engaged in consuming and displaying content while the content is being shared with the remote device.

### SUMMARY

The subject disclosure relates generally to sharing content, and more particularly to wirelessly transferring content between two or more devices.

The subject disclosure relates to a machine-implemented method for wirelessly transferring content. The method includes transferring content from a first device to a second device in response to a request from the first device to transfer the content, analyzing the transferred content at the second device, to determine a type of the transferred content and providing the transferred content for display at the second device according to the determined type of the transferred content.

The subject disclosure also relates to a machine-readable medium comprising instructions stored therein, which when executed by the processors, cause the processors to perform operations that include receiving at a second device an indication that content is transferring to the second device from a first device, wherein content comprises an encoded content file or a pointer to referenced content, accepting the transferred content at the second device, and analyzing the transferred content at the second device, to determine a file type of the transferred content or a location of the transferred content, wherein the location of the transferred content corresponds to the pointer to referenced content. The operations also include providing the transferred content for display at the second device according to the determined file type of the transferred content or the location of the transferred content, wherein providing the transferred content for display at the second device according to the determined file type of the transferred content or the location of the transferred content comprises determining, at the second device, a computer application that corresponds to the determined file type and displaying the transferred content in the corresponding computer application.

The subject disclosure further relates to a system for wirelessly transferring content from a first device to a second device. The system includes a request module, configured to receive a request to transfer content from a first device to a second device, wherein, the user-identified content comprises an encoded content file or a pointer to referenced content, a transfer module, configured to transfer the content from the first device to the second device, in response to the received request and a receiving module, configured to receive the transferred content at the second device. The system also includes a processing module, configured to analyze the transferred content to determine a file type of the transferred content or a location of the transferred content, wherein the location of the transferred content corresponds to the pointer to referenced content, a display module, configured to provide the transferred content for display at the second device according to the determined type of the transferred content or the location of the transferred content and an application selection module, configured to select a computer application that corresponds to the determined file type and cause the transferred content to be displayed in the corresponding computer application. The system furthermore includes a content accessing module, configured to access referenced content at the determined location when providing the transferred content for display according to the location of the transferred content and a pairing module, configured to pair the first device with the second device prior to wirelessly transferring content.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an exemplary system for wirelessly transferring content.

FIG. 2 illustrates a flow diagram of an example process for wirelessly transferring content.

FIG. 3 conceptually illustrates an example of a system for wirelessly transferring content.

FIG. 4 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, to one ordinarily skilled in the art that the configurations of the present disclosure may be practiced without some of these specific details. In other instances, well-known structures and techniques have not been shown in detail so as not to obscure the disclosure.

Methods and systems for wirelessly transferring content are provided herein. A request to wirelessly transfer content from a first device to a second device is received at a first device. Example devices may be a personal computer, smart phone, tablet computer, lap top computer, a television or another computing device. According to an aspect of the disclosed technology, a user may initiate the request to wirelessly transfer content at the first device. The second, or recipient device may be, for example, a television. The content that is the subject of the transfer request may be expressly identified or selected by the user. The user may select a file by, for example, highlighting the file, right-clicking on the file, or by pointing to the file in the first device's file directory. The user may then indicate his or her intent to transfer the selected file to a second device by, for example, pressing a button, selecting a transfer option from a menu or dragging the selected content to a zone that is predetermined to hold files intended for transfer, (e.g., hot zone). Each zone may be associated with a different recipient device. The second device accepts the transferred content, analyzes or processes the content, and the user consumes the content at the recipient device.

A user may select the second device explicitly, by selecting the device through a GUI, or implicitly, by, for example, flinging the selected file in a direction that is predetermined to correspond to a paired device. For example, a transfer may be implemented by flinging a file into the lower right corner in order to transfer the file to a television, whereas, flinging a file into the upper left corner transfers the file to another device, such as a tablet.

There may be one or more recipient devices accessible from a device from which content is transferred. The devices are paired prior to any content being transferred. When a transfer is initiated and it is determined that the devices are not paired, a pairing process may be automatically initiated to facilitate the transfer. For example, if a recipient device that has not previously been paired is detected within a predetermined range of distance to a device that initiates a transfer to the recipient device, the devices are paired prior to or contemporaneously with the content transfer.

Content, as used herein, may be an encoded content file, such as, for example, a document, a digital image, a video file, a music file or another type of content file. Alternatively, content may be designated by a pointer to referenced content, such as a URL or a hyperlink. In addition, content may be augmented prior to being transferred. For example, content may be compressed, zipped or otherwise modified to facilitate its transfer to the second device.

In response to the received content transfer request, content is wirelessly transferred from the first device to the second device. Once the transferred content is received and accepted at the second device, the transferred content is analyzed. That is, the second device identifies what kind of content was transferred and how the transferred content should be displayed. The second device may look at a file extension in the transferred content and identify the MIME type. If the transferred content is an encoded content file, the encoded content file is analyzed to identify a file type of the transferred content. If the transferred content is a pointer to referenced content, such as an URL or a hyperlink, the transferred content is analyzed to determine the location of the transferred content, so the second device may browse to that location and access the content.

After being analyzed, the transferred content is provided for display at the second device according to at least one of the identified file type of the transferred content or the location of the transferred content. When the transferred content is provided for display according to the location of the transferred content, the second device accesses the location to display the transferred content. For example, in a case where the transferred content is a URL, the second device browses to the URL to access whatever content is located at the URL. Thus, the second device is not merely an extension of the first device. The second device receives content, identifies what the content is and how to display the received content, and displays the content locally on the second device, whether by accessing the referenced file or by displaying the encoded file that was transferred from the first device.

Additionally, a user may control content at the recipient device through the device that transfers the content. For example, the device that transfers the content to the recipient device may send a set of consistent control keys (e.g., play, pause, fast forward, rewind) to the recipient device, along with the content. As such, a user may manipulate content at the recipient device through the device used to transfer the content.

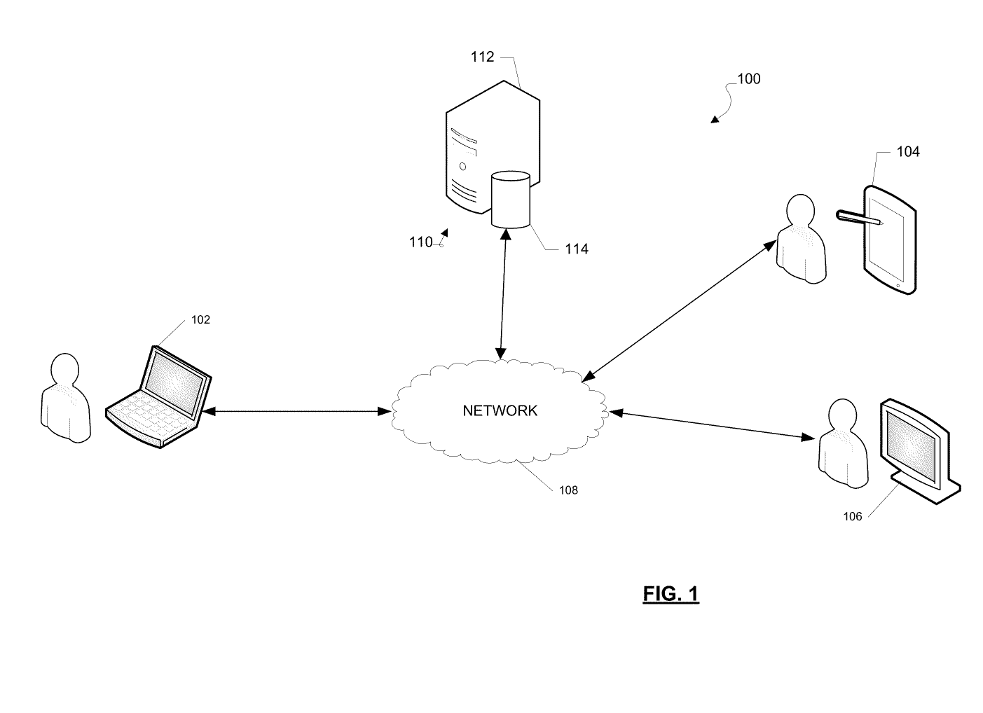

FIG. 1 illustrates an example client-server network which provides for wirelessly transferring content. A network display 100 includes a number of electronic devices 102, 104 and 106 communicably connected to each other and a server 110 by a network 108. Server 110 may host an application within which some of the processes discussed herein are implemented and may include a processing device 112 and a data store 114. Processing device 112 executes computer instructions stored in data store 114, for example, instructions to transfer content, analyze transferred content and accessed referenced content. Data store 114 may store information pertaining to, for example, user settings and preferences including a number of attempts to confirm that user-identified content has been received at a device, device pairing settings, or information pertaining to previously accessed referenced content. According to an aspect of the disclosed technology, data store 114 may also store transferred content. The content may be stored temporarily, during the transfer process, in case of errors during the transfer. Alternatively, the content may be stored for a longer period of time, for the user's convenience. For example, a user may store a number of recently transferred items in data store 114.

For example, data store 114 may store information pertaining to a segment or a portion of content previously viewed by a user, such that a device may resume displaying content from where a user may have left off. Furthermore, when the transferred content item is “playing” on the first device when sent to the second device, the system continues to play the content on the second device, without causing the content to play from the beginning

In some example aspects, electronic devices or client devices, as used interchangeably herein, 102, 104 and 106 can be computing devices such as tablet computers, a laptop computers or televisions (‘TV”) or other displays with one or more processors coupled thereto or embedded therein, or other appropriate computing devices that can be used for wirelessly transferring content. Electronic devices 102-106 may have one or more processors embedded therein or attached thereto, or other appropriate computing devices that can be used for accessing a host, such as server 110. In the example of FIG. 1, electronic device 102 is depicted as a laptop computer, electronic device 104 as tablet computer, and electronic device 106 is depicted as a TV. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

According to one aspect, the system 100 detects a request from a first client device (e.g., electronic device 102) to transfer content to a second device (e.g., electronic device 106). Upon detecting the transfer request, the system (e.g., electronic device 102, electronic device 106 or server 110) determines whether the first device and the second device are paired. Each time the content transfer request is received at the first device, the system checks whether the second device that is selected by the user to receive the transferred content is paired to the first device. When the devices have not previously been paired, the system (e.g., server 110) pairs the devices. When the devices are determined to have been paired, the system transfers content selected by the user from the first device to the second device over the network 108.

In some example aspects, server 110 can be a single computing device such as a computer server. In other configurations, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

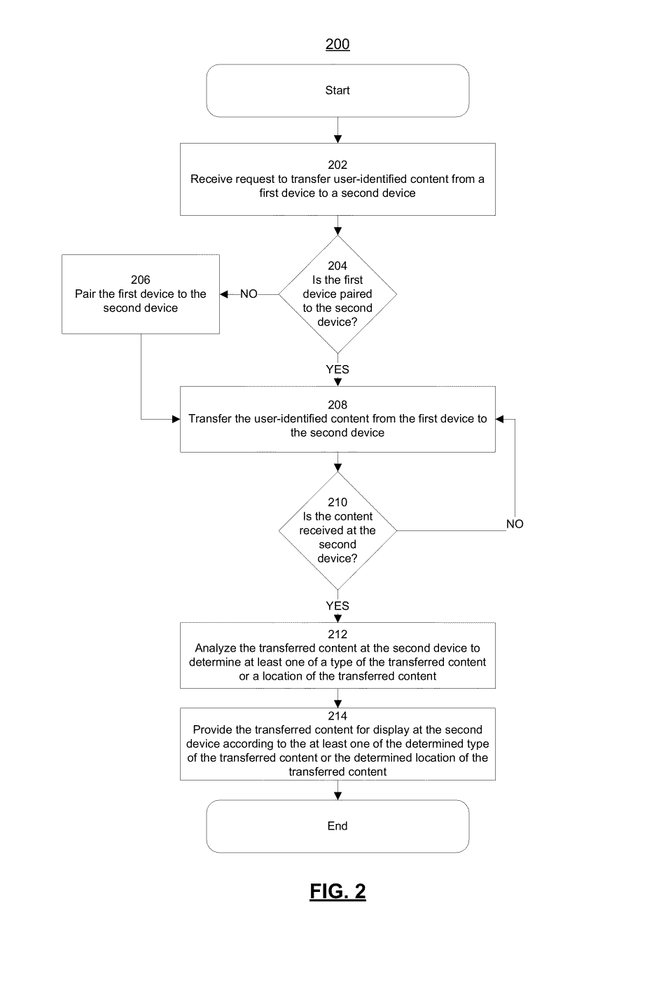

FIG. 2 illustrates a flow diagram of an example process 200 for wirelessly transferring content. Process 200 starts and at block 202, the system receives a request to transfer content from a first device to a second device. Content may be identified by a user by any method including, but not limited to, highlighting a content item and selecting a transfer option from an operating system menu, right-clicking on a content item and selecting a transfer option from a menu, dragging a content item to a graphic user interface corresponding to a second device or to a general content transfer area, or by selecting and flicking a content item in a direction associated with a second device.

The user may identify or select the second device. There may be one or more receiving devices accessible from the first device. A user may select the second device explicitly, by selecting the device through a GUI, or implicitly, by, for example, flinging a selected content item in a direction that is predetermined to correspond to a second device. The second device may be selectable at the first device when the second device has been paired or when the second device is detected to be within a predetermined range of distance to the first device. That is, a second device may be dynamically added or removed from a list of available devices, depending on the location of the first device and of the second device. A device may be detected by wireless signal triangulation, Bluetooth technology or the like.

In response to the received request to transfer content to a second device, the system confirms at block 204 whether the first device is paired to the second device. The system may, for example, dispatch a query to confirm an association between the devices or send a communication to the second device asking the device to confirm the relationship. If the first and second device have not previously been paired, the system initiates a pairing process at block 206. If the system determines that the first and second device have previously been paired, the system continues to block 208 and transfers the user-identified content from the first device to the second device.

According to one aspect, the user-identified content may be an encoded content file, such as, for example, a document, a digital image, a video file, a music file or another type of content file. Alternatively, content may be a pointer to referenced content, such as an URL or a hyperlink, for example. Content may be augmented prior to being transferred. For example, content may be compressed, zipped or otherwise modified to facilitate its transfer to the second device.

After transferring the content from the first device, at block 210 the system confirms at the second device whether the content has been received. The confirmation may be in the form of a query or another similar mechanism for confirming the transfer. When the transfer is not confirmed, the system may attempt the transfer again. If the transfer is unsuccessful after a predetermined number of tries (e.g., 5), the system may cancel the process 200. An additional determination may be made at the second device regarding whether or not to accept the transferred content. Content may be rejected when, for example, content type is unsupported, the content is corrupt, suspicious or too large.

When the system confirms the transfer at block 210, and the content has been accepted by the second device, the system proceeds to block 212 to analyze the transferred content. The transferred content is analyzed at the second device to determine either a type of the transferred content or a location of the transferred content. When the transferred content is an encoded content file, analyzing the transferred content at the second device may include determining a file type of the transferred content. When the transferred content is a pointer to referenced content, analyzing the transferred content at the second device may include determining a location of the transferred content. The determined location of the transferred content corresponds to the pointer to referenced content.

That is, the second device identifies what kind of content was transferred and how the transferred content should be displayed. The second device may look at a file extension of the transferred content and identify the MIME type. If the transferred content is an encoded content file, the encoded content file is analyzed to identify a file type. If the transferred content is a pointer to referenced content, such as an URL or a hyperlink, for example, the transferred content is analyzed to identify the location of the transferred content, so the second device may browse to that location and access the content.

The transferred content is provided for display at the second device according to at least one of the identified file type of the transferred content or the location of the transferred content at block 214. Providing the transferred content for display according to the determined file type of the transferred content may further include determining a computer application that corresponds to the identified file type and displaying the transferred content in the corresponding computer application.

Providing the transferred content for display at the second device according to specifications of the location of the transferred content may further include accessing the referenced content at the determined location. That is, when the transferred content is provided for display according to the location of the transferred content, the second device accesses the location to display the transferred content. For example, in a case where the transferred content is a URL, the second device browses to the URL to access whatever content is located at the URL.

The second device, therefore, is not merely an extension of the first device. The second device receives content, identifies what the content is and how to display the received content, and displays the content locally on the second device, whether by accessing a referenced file or by displaying the encoded file that was transferred from the first device.

Furthermore, the second device may analyze the transferred content to determine whether the content should be played from the beginning or whether part of the content has already been consumed by the user. That is, when the transferred content item is “playing” on the first device the system continues to play the content on the second device, without causing the content to restart from the beginning Metadata may be included with the transferred content that tells the second device where to begin playing the transferred content. Such metadata may be generated at the first device or at a server facilitating the content transfer, and transferred along with the content.

Likewise, a determination may be made at the second device as to whether or not the user has previously viewed the transferred content. For example, the system may detect that the user viewed a video “n” number of days ago and provide the user with an option to resume playing the content or to re-start from the beginning

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing display. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

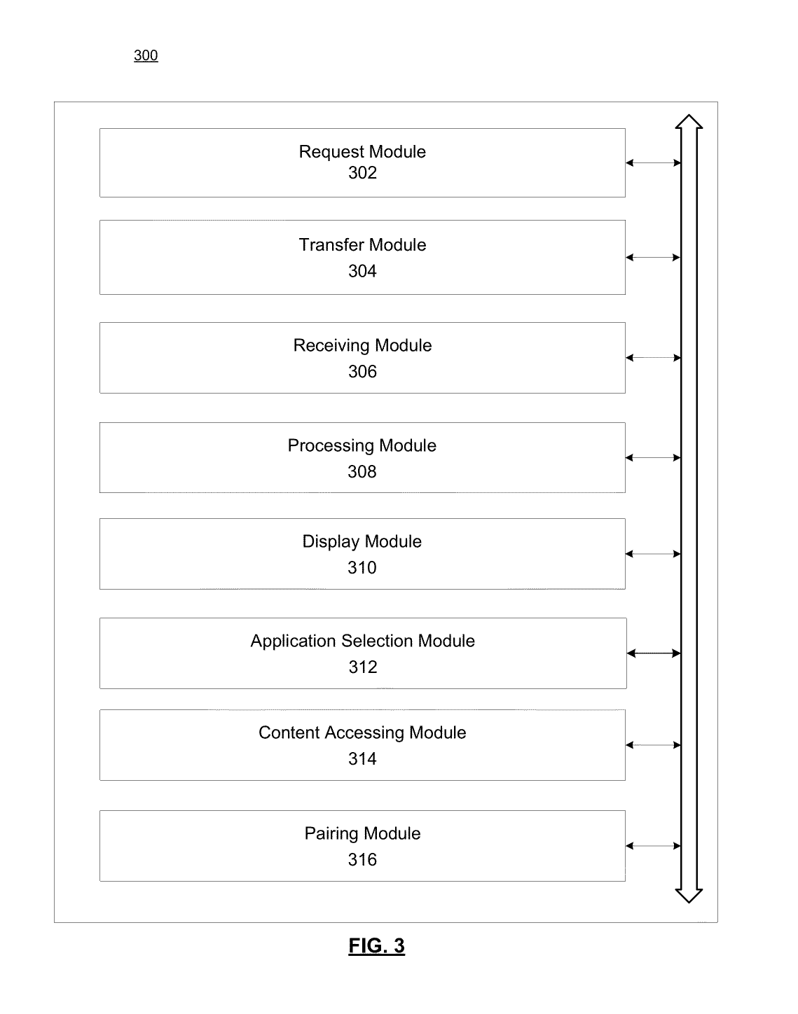

FIG. 3 illustrates an example of system 300 for wirelessly transferring content, in accordance with various aspects of the subject technology. System 300 comprises a request module 302, a transfer module 304, a receiving module 306 and a processing module 308. The system also includes a display module 310, an application selection module 312, a content accessing module 314 and a pairing module 316.

The request module 302 is configured to receive a request to transfer content from a first device to a second device, wherein, the content comprises an encoded content file or a pointer to referenced content. The transfer module 404 is configured to transfer the content from the first device to the second device, in response to the received request. The receiving module 306 is configured to receive the transferred content at the second device. The processing module 308 is configured to analyze the transferred content to determine a file type of the transferred content or a location of the transferred content, wherein the location of the transferred content corresponds to the pointer to referenced content.

The display module 310 is configured to provide the transferred content for display at the second device according to the determined type of the transferred content or the location of the transferred content. The application selection module 312 is configured to select a computer application that corresponds to the determined file type and cause the transferred content to be displayed in the corresponding computer application. The content accessing module 314 is configured to access referenced content at the determined location when providing the transferred content for display according to the location of the transferred content. The pairing module 316 is configured to pair the first device with the second device prior to wirelessly transferring content.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

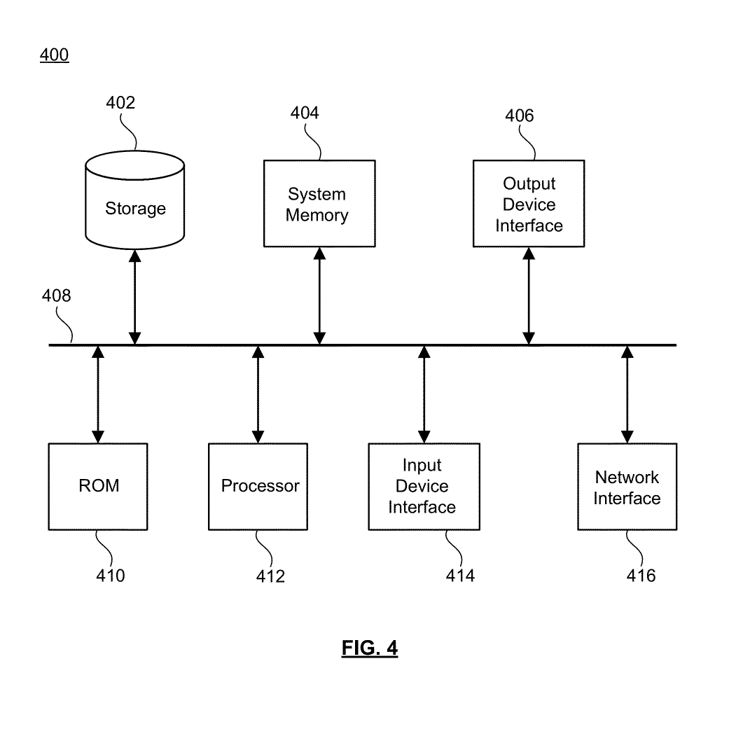

FIG. 4 conceptually illustrates an electronic system with which some aspects of the subject technology are implemented. Electronic system 400 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method for wirelessly transferring content, the method comprising:
transferring content from a first device to a second device in response to a request from the first device to transfer the content;
analyzing the transferred content at the second device, to determine a type of the transferred content; and
providing the transferred content for display at the second device according to the determined type of the transferred content.

2. The computer-implemented method of claim 1, wherein the content is identified by a user.

3. The computer-implemented method of claim 1, wherein transferring the content to the second device comprises identifying the second device.

4. The computer-implemented method of claim 3, wherein identifying the second device comprises receiving an indication of a user selection of the second device.

5. The computer-implemented method of claim 1, wherein, the content comprises an encoded content file or a pointer to referenced content.

6. The computer-implemented method of claim 5, wherein, in a case the transferred content is an encoded content file, analyzing the transferred content at the second device comprises determining a file type of the transferred content.

7. The computer-implemented method of claim 6, further comprising providing the transferred content for display according to the determined file type of the transferred content.

8. The computer-implemented method of claim 7, wherein providing the transferred content for display at the second device according to the determined file type of the transferred content comprises:
determining a computer application that corresponds to the determined file type; and
displaying the transferred content in the corresponding computer application.

9. The computer-implemented method of claim 5, wherein, in a case the transferred content is a pointer to referenced content, analyzing the transferred content at the second device comprises determining a location of the transferred content, wherein the determined location of the transferred content corresponds to the pointer to referenced content.

10. The computer-implemented method of claim 9, providing the transferred content for display at the second device according to the determined location of the transferred content comprises providing the transferred content for display according to specifications of the location of the transferred content.

11. The computer-implemented method of claim 10, wherein providing the transferred content for display according to the specifications of the location of the transferred content comprises accessing the referenced content at the determined location.

12. A machine-readable medium comprising instructions stored therein, which when executed by the processors, cause the processors to perform operations comprising:
receiving at a second device an indication that content is transferring to the second device from a first device, wherein content comprises an encoded content file or a pointer to referenced content;
accepting the transferred content at the second device;
analyzing the transferred content at the second device, to determine a file type of the transferred content or a location of the transferred content, wherein the location of the transferred content corresponds to the pointer to referenced content; and
providing the transferred content for display at the second device according to the determined file type of the transferred content or the location of the transferred content, wherein providing the transferred content for display at the second device according to the determined file type of the transferred content or the location of the transferred content comprises determining, at the second device, a computer application that corresponds to the determined file type and displaying the transferred content in the corresponding computer application.

13. The machine-readable medium of claim 12, wherein, providing the transferred content for display according to the location of the transferred content comprises accessing the referenced content at the identified location.

14. The machine-readable medium of claim 12, wherein, in a case the transferred content is a pointer to referenced content, analyzing the transferred content at the second device comprises determining a location of the transferred content, wherein the determined location of the transferred content corresponds to the pointer to referenced content, and, wherein, in a case the transferred content is an encoded content file, analyzing the transferred content at the second device comprises determining a file type of the transferred content.

15. The machine-readable medium of claim 12, wherein the second device is paired with the first device.

16. The machine-readable medium of claim 12, wherein the content is transferred wirelessly.

17. A system for wirelessly transferring content from a first device to a second device, the system comprising:
a request module, configured to receive a request to transfer content from a first device to a second device, wherein, the content comprises an encoded content file or a pointer to referenced content;
a transfer module, configured to transfer the content from the first device to the second device, in response to the received request;
a receiving module, configured to receive the transferred content at the second device;
a processing module, configured to analyze the transferred content to determine a file type of the transferred content or a location of the transferred content, wherein the location of the transferred content corresponds to the pointer to referenced content; and
a display module, configured to provide the transferred content for display at the second device according to the determined type of the transferred content or the location of the transferred content.

18. The system of claim 17, further comprising:
an application selection module, configured to select a computer application that corresponds to the determined file type and cause the transferred content to be displayed in the corresponding computer application.

19. The system of claim 17, further comprising:
a content accessing module, configured to access referenced content at the determined location when providing the transferred content for display according to the location of the transferred content.

20. The system of claim 17, further comprising:
a pairing module, configured to pair the first device with the second device prior to wirelessly transferring content.
